(19) United States
(12) Patent Application Publication
(10) Pub. No.: US 2007/0043897 A1
(43) Pub. Date: Feb. 22, 2007

(54) Method and device for storing information

(75) Inventors: Johannes Friso Rendert Blacquiere, EINDHOVEN (NL); Gerrit Jan Scholl, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/539,325

(22) PCT Filed: Dec. 2, 2003
(86) PCT No.: PCT/IB03/05691

§ 371 Date: Jun. 15, 2005

(30) Foreign Application Priority Data
Dec. 20, 2002 (EP) 02080529.7

(51) Int. Cl. G06F 12/00

(52) U.S. Cl. 711/100

(57) ABSTRACT

A method is described for writing an optical disc (2) having a user storage space (USS). The method comprising the steps of determining a reserved storage section (VRSS 80) of the user storage space (USS) for use by a specific application;—determining which parts (81) of said reserved storage section (VRSS 80) are free for writing, i.e. not occupied;—allocating all addresses in those free parts (81) to a reservation file (VRF).

### FIELD OF THE INVENTION

The present invention relates in general to a method and device for storing information on a recordable storage medium. More particular, the present invention relates to a method and device for storing information on a recordable optical disc. Specifically, the present invention relates to storing information on a user-recordable Digital Versatile Disc (such as DVD+RW or DVD-RW), and the invention will hereinafter be explained specifically for this example; however, it is to be understood that the present invention is not restricted to DVDs, and that its teaching is applicable in other fields.

### BACKGROUND OF THE INVENTION

Optical discs in general are known. As is commonly known, an optical disc has a storage space which physically has the shape of a track, either in the shape of a plurality of concentric circular tracks or one (or more) continuous spiral shaped track. Data can be written on the track by means of an optical beam, such optical beam changing certain properties of the disc. Writing occurs at a specific storage location, which has a specific logical address and a specific physical position.

Since the technology of storing information on optical discs in general is known per se, a more detailed description of this technology is omitted here. Similarly, since the technology of storing information on DVDs is known per se, a more detailed description of this technology is omitted here.

The information to be written can be of different types. For instance, it is possible that the information consists of a video recording, but it is also possible that the information consists of computer data. Other types of information are feasible, too. Typically, the writing operation is performed by a user application according to predefined protocols or formats, as will be known to a person skilled in the art. Typically, for different types of information, the corresponding formats are different. For instance, the format for video differs from the format for computer data. This difference does not only come to expression in the data coding formulas, but also in the way how the data is organized on disc. For instance, the video format requires that a recording is substantially contiguous, whereas computer data may in principle be scattered over the entire disc, organized in files, while a file managing system keeps a table of information relating to the storage locations of the files, which table is stored on disc.

The user applications may be designed to operate according to one format only. For instance, a video recorder apparatus is designed, in principle, to write video according to video format only. Conventional computers are designed to write computer data according to data format only.

More recent apparatus are capable to handle both types of formats. For instance, a modem DVD video recorder apparatus is designed to put the recordings and additional information in a set of files, so that the recordings become visible in a PC. Conversely, modern personal computers comprise a video application, allowing a user to view or record video.

A problem is that different recording formats have different requirements regarding the allocation of information on disc. A further problem is that different recording formats do not respect each others requirements. The most important source of these problems is that the individual formats have been developed on the basis of the assumption that a specific disc would be used for one purpose only, i.e. video only or PC data only. Indeed, if a user would restrict the use of a disc to either video or PC data, he would encounter no problems. However, it is desirable to allow one disc for recording video as well as PC data.

For instance, after a video recording operation, the storage space of the disc contains a number of regions with video information written therein, while in between those written regions the storage space of the disc contains a number of empty regions. A video recording application, whether a video recording apparatus or a PC video recording application, will need these empty regions for future recordings. However, if the disc would be used in a personal computer for storing computer data, the computer may not know the video format requirements and may, therefore, not respect those requirements, so that computer data is written in the empty spaces left in between the video recordings. If, later, it is desired that a further video recording is stored on this disc, it may be that the video recording application does not recognize or at least does not respect the computer data in said “empty” spaces, in which case the video recording application will simply overwrite said computer data, or it may be that the video recording application does respect the computer data in said “empty” spaces, in which case the video recording application may be no longer capable of recording video at all.

In order to avoid this problem, prior art proposes to subdivide the storage space of the disc in two or more partitions, each partition being intended for storing a specific information type, for instance a video partition and a computer data partition. One disadvantage of this approach is that partitioning needs to be done on formatting of the disc, before data is written for the first time. It is, in fact, possible to change the partitioning later, but this is difficult and requires much work and therefore much time, particularly with a view to maintaining all existing data on disc: these need to be shifted to another location, or all address information needs to be updated.

Another disadvantage is that, for each type of information, the size of the storage space is limited to the size of the corresponding partition; for instance, it is not possible to write video in the computer data partition.

The present invention aims to provide a solution to these problems which does not suffer from such disadvantages.

### SUMMARY OF THE INVENTION

According to an important aspect of the invention, an application which has certain allocation requirements is designed to create a file occupying storage space which corresponds to said allocation requirements. Such file will hereinafter be indicated as reservation file.

Specifically, a video application is designed to declare a reservation file occupying the empty space needed for future video recordings.

Thus, effectively, the video application claims and secures the empty space needed for future video recordings. Any other application, especially a computer application, is effectively prevented from writing in said space because such application sees said space as being occupied by a file. This applies to any application except a video application designed in accordance with the present invention, which will recognize that the file only serves the purpose of securing space which may be used for recording video. Older video applications, not being designed in accordance with the present invention, will ignore the reservation file anyway, and will select storage space on the basis of video-specific recording location information only.

### BRIEF DESCRIPTION OF THE DRAWINGS

These and other aspects, features and advantages of the present invention will be further explained by the following description of preferred embodiments of the method according to the present invention with reference to the drawings, in which same reference numerals indicate same or similar parts, and in which:

FIG. 1 is a functional block diagram, schematically illustrating a disc drive;

FIGS. 2-4 a chematically illustrate storage space of a disc.

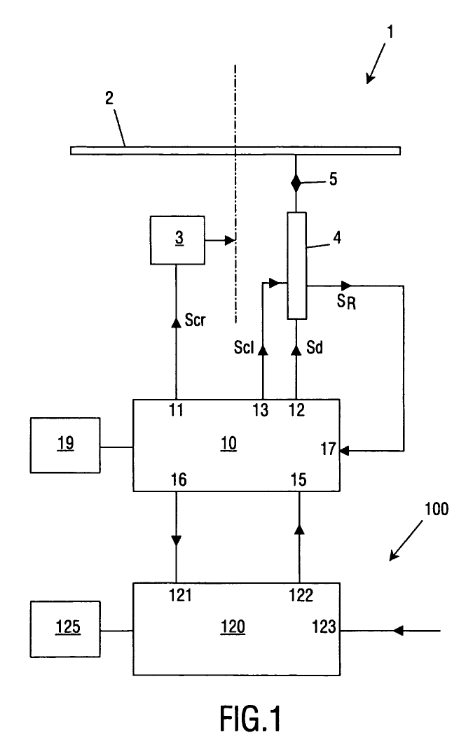

FIG. 1 schematically shows relevant components of a DVD disc drive apparatus, generally indicated with reference numeral 1. The disc drive 1 comprises receiving means (not shown for sake of convenience) for receiving a DVD 2, and rotating means 3, typically including a motor, for rotating the DVD 2 at a predetermined rotational speed. Since such receiving means and rotating means are well known in prior art, it is not necessary here to explain their design and functioning in detail.

As is commonly known, a DVD 2 comprises tracks for writing data, and written data can be read from the tracks. The tracks may be implemented as a plurality of separate, circular tracks, mutually concentric, but the tracks may also be implemented as consecutive turns of a unique, continuous spiral-shaped track. For the context of the present invention, the type of track is not important.

For reading and writing data by optical means, the disc drive 1 further comprises an optical system 4 which comprises light beam generating means arranged for scanning the surface of the rotating disc 2 with an optical beam 5, and which comprises an optical detector for receiving a beam reflected from the disc and for deriving a read signal S_{R} from the reflected beam. Typically, the light beam is a laser beam, generated by a laser diode. Since in general such optical system is well known in prior art, it is not necessary here to explain its design and functioning in detail.

The disc drive 1 further comprises a disc drive system 10, designed to control the rotating means 3 and the optical system 4 for performing a write operation at a certain location. In FIG. 1, the disc drive system 10 is illustrated as having an input 17 for receiving the read signal S_{R}. Further, the disc drive system 10 is illustrated as having a first output 11 providing a first control signal Scr controlling the operation of the rotating means 3. Further, the disc drive system 10 is illustrated as having a second output 12 providing a data signal Sd to the optical system 4. The disc drive system 10 is further illustrated as having a third output 13 for providing a second control signal Scd for the optical system 4. The data signal Sd represents the information to be written into the optical disc 2. As will be clear to a person skilled in the art, the disc drive system 10 determines at what disc location to write the data by generating a suitable combination of the control signals Scr and Scl. Since such disc drive system 10 is known per se, it is not necessary here to explain its design and functioning in detail.

The disc drive 1 is incorporated in a host system 100, capable of writing video recordings on disc. In the present example, it will be assumed that the host system 100 is a video recorder apparatus. However, it should be clear that the following explanation is also applicable to any other type of video recording application, such as for instance a personal computer having a video recording facility, i.e. a video recording program running on a personal computer.

The video recorder apparatus 100 comprises a signal processing system 120 having an input 121 coupled to an output 16 of the disc drive system 10, and having an output 122 coupled to an input 15 of the disc drive system 10. The signal processing system 120 further has a video data input 123 for receiving video data to be stored from any suitable source, for instance a video tuner (not shown) coupled to a cable distribution system (not shown) or an antenna (not shown). The signal processing system 120 is designed for handling the writing of video recordings to disc, i.e. to suitably encode incoming video data according to a predefined video writing format, such as for instance the DVD+RW video format specification (also indicated as DVD+VR), and to generate suitable instructions for the disc drive 1 in order to write the encoded video data at a disc location determined by the signal processing system 120, as will be clear to a person skilled in the art.

The video recorder apparatus 100 further comprises a memory 125 associated with the signal processing system 120.

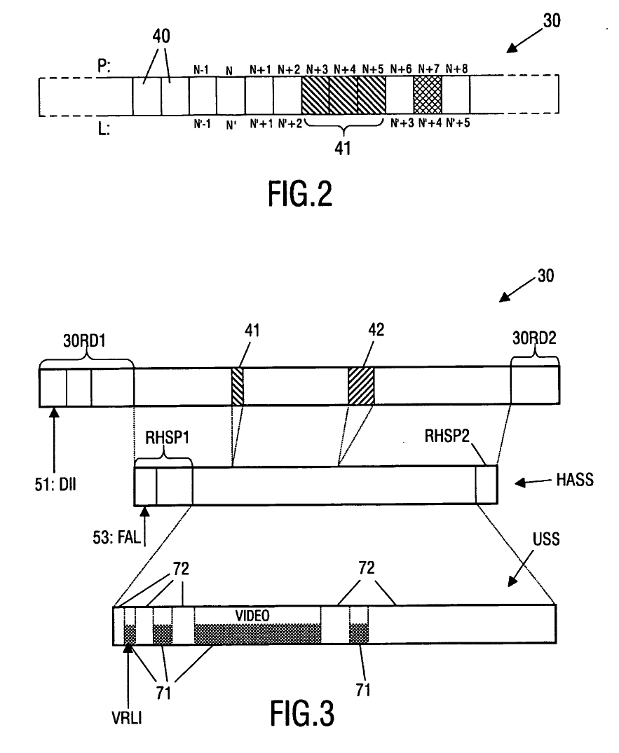

FIG. 2 is a diagram schematically illustrating a storage space 30 of the DVD 2 as a continuous ribbon, divided into storage blocks 40. Each storage block can contain a predetermined number of data bits, as will be known to a person skilled in the art. Each storage block 40 has a unique physical disc address, which substantially corresponds to the physical position of such block on the disc. In FIG. 2, the physical disc addresses P of the blocks 40 are indicated as consecutive numbers, each block 40 having a physical disc address corresponding to the physical disc address of its predecessor plus one.

As illustrated in FIG. 2, the logical blocks 40 also have a logical disc address L, allocated by the drive system 10. Logical addresses may differ from physical disc addresses. An important difference is that not all usable blocks are given a logical disc address. For instance, the drive system 10 may have defined spare areas for defect management, such as described in the Mount Rainier standard. Such spare areas are not available for normal storage of user data, i.e. they are not visible to a user and they do not have obtained logical addresses. In the example of FIG. 2, a spare area 41 contains blocks having physical disc addresses N+3, N+4 and N+5.

As another example, in DVD, the drive system 10 reserves the first 30000[HEX] blocks for lead in, so that logical disc address L=1 corresponds to physical disc address P=30001.

FIG. 3, similar to FIG. 2, also shows the storage space 30 as a ribbon, but now on a different scale. While FIG. 2 illustrates individual blocks of a very small portion of the storage space 30, FIG. 3 shows the entire storage space 30.

In the example illustrated in FIG. 3, two portions 30RD1 and 30RD2, also indicated as lead-in area and lead-out area, respectively, which are made during formatting of the disc, are reserved for use by the disc drive system 10 itself, i.e. these portions of the storage space 30 are not available for storing user data. The drive system 10 has allocated logical disc addresses to the remaining part of the storage space 30, with the exception of spare areas 41 and 42. The drive system 10 uses the logical disc addresses to make this part of the storage space 30, indicated hereinafter as host available storage space HASS, available to the signal processing system 120 of the video recorder apparatus 100.

The mapping of physical disc addresses to logical disc addresses is usually done in accordance with a predefined standard, for instance the DVD+RW standard or the DVD+MRW standard (Mount Rainier standard). A certain first portion 51 of the reserved storage space 30RD1 contains information identifying the format of the disc, so that the relation between physical disc addresses and logical disc addresses can be derived by the disc drive system 10. This information will be indicated as disc identification information DII.

The signal processing system 120 performs a remapping of the logical disc addresses as defined by the disc drive, so as to define a logical space to a user, indicated hereinafter as user storage space USS, available for storing user video data. Herein, the signal processing system 120 reserves parts of the host available storage space HASS for its own use, which reserved parts will hereinafter be indicated as reserved host storage portions RHSP1 and RHSP2; the remaining part of host available storage space HASS is made available for a user as user storage space USS; logical addresses in this user storage space USS are indicated as logical user addresses.

When a DVD is placed into a disc drive, the disc identification information DII in the said portion 51 of the reserved storage space 30RD1 is copied into a memory 19 associated with the drive system 10, so that the drive system 10 knows which physical disc addresses P correspond to logical disc addresses L.

When storing information into the disc, the signal processing system 120 determines logical user addresses for the data to be stored, and translates these logical user addresses into logical disc addresses L, which are translated into physical disc addresses P by the disc system 10, taking into account the disc identification information DII in said portion 51 of the reserved storage space 30RD1.

FIG. 3 illustrates a user storage space USS which contains one or more video recordings. The hatched area 71 represents storage space which actually contains video data written therein; the remaining area 72 is empty, i.e. it has never been written yet, or its contents has been deleted and area 72 is now available for new recordings.

The signal processing system 120 keeps record of the video recordings written to disc. This information, which will hereinafter be indicated as video recording location information VRLI, and which involves inter alia the logical user addresses of the recordings, is stored in said memory 125, and is also written in one of the areas 71 on disc in accordance with the predefined DVD format; in FIG. 3, this video recording location information VRLI is illustrated as being written in the leftmost area 71. Thus, other video applications are able to read said information.

The VRLI defines the location and extent of the recorded areas 71 in general, more specifically the start addresses of individual video recordings. The VRLI is used for locating a specific recording if it is desired to play this recording. The VRLI is also used by a video application which is about to write a new recording. The signal processing system 120 will determine a start address for the new recording, which may be next to the end of the last recording or, if the user wishes to record over an already existing recording, the beginning of such existing recording. If the new recording overwrites any of the additional video files, for instance the rightmost area 71 in FIG. 3, the information in this file is written again, updated if necessary, beyond the end of the new recording, so that the structure illustrated in FIG. 3 is maintained, albeit that the size of one or more of the areas 71 has increased while also the location of one or more of the areas 71 may have changed.

By using the VRLI in this way, video applications respect already existing recordings.

Computers have a different format for writing data. Computer data is written in the form of files, and a list of the files stored by the user is stored in a portion 53 of the reserved host storage portion RHSP1 (as illustrated in FIG. 3), or in file system descriptors stored in the user storage space USS. This list, which includes the logical disc addresses corresponding to the files stored by the user, is indicated as file allocation list FAL. When writing new data, a file system of a computer will consult the file allocation list FAL in order to find free storage space. However, conventional general purpose computers are not designed to consult the VRLI, and are not even capable of recognizing that the disc contains video recordings. For such conventional general purpose computers, it is only the file allocation list FAL which is consulted.

The signal processing system 120 of the video recorder apparatus 100 is designed to declare the recorded areas 71 as one or more files in the file allocation list FAL, using the standard computer format for information in the file allocation list FAL. These one or more files will hereinafter be indicated by the general phrase video file VF. As a result, any conventional general purpose computer will recognize the areas 71 corresponding to the video file VF as occupied storage space, and such computer is effectively prevented from writing any data in these areas 71. Thus, the video recordings in these areas 71 are effectively protected against overwriting by computer data.

Assuming that no computer data have been written in the user storage space USS yet, such conventional general purpose computer will, after having consulted the file allocation list FAL, consider all non-written areas 72 as being free storage space, free for storing computer data When such computer receives a command to store data, its file system will select a storage location within this assumed free storage space, usually the first available address within this assumed free storage space. However, this will usually involve storage space which a video recording application would need if later a further video recording is to be written to disc.

Now, there are two possibilities. One possibility is that such video recording application only consults the video recording location information VRLI for selecting a starting location for new recordings. In such case, the video recording application ignores any computer data which may have been written in the selected areas 72; as a consequence, such computer data is destroyed by being overwritten by a new video recording. Conventional video recording applications operate in this way.

Another possibility is that such video recording application also consults the file allocation list FAL for selecting a starting location for new recordings. In such case, the video recording application will find that computer data have been written in one or more of the areas 72. However, in accordance with the format for video recordings, the video recording application needs one or more of these areas for writing the recording. These areas now being occupied by computer data effectively means that the video recording application is prevented from making any further recordings.

Present day video recorders prevent these problems by declaring the disc as being read-only. This effectively prevents a computer from writing any computer data at all, while a video recording application will recognize that the disc is available for video recordings. However, in such case the disc is not available for writing computer data at all. The present invention aims to overcome this disadvantage, by allowing the computer to write computer data in a certain area but effectively forbidding the computer to write computer data in areas which are needed for future video recording.

In order to prevent the above-mentioned problems, the signal processing system 120 of the video recorder apparatus 100 is designed to declare part of the non-recorded areas 72 as one or more files in the file allocation list FAL, using the standard computer format for information in the file allocation list FAL. These one or more files will hereinafter be indicated by the general phrase video reservation file VRF.

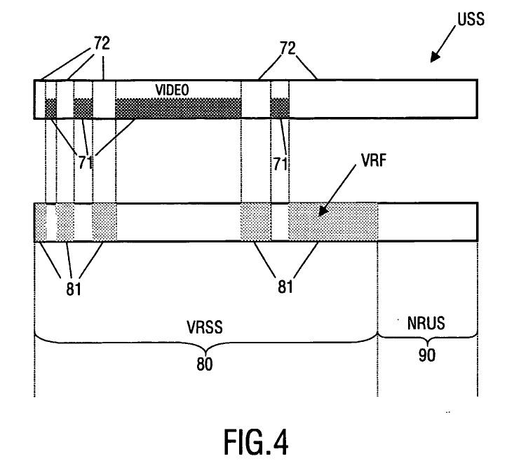

FIG. 4 illustrates an example of such video reservation file VRF. The addresses allocated to this video reservation file VRF together define reserved storage areas 81, which correspond to most of the non-recorded areas 72. The reserved storage areas 81, together with the recorded areas 71, effectively define a contiguous part of the user storage section USS, which part will be indicated as video-reserved storage section VRSS 80. As prescribed in the video format, this video-reserved storage section VRSS 80 extends from the start of the user storage space USS, ending well before the end of the user storage space USS, thus leaving a non-reserved part 90 of the user storage space USS available for other applications. This non-reserved part 90 of the user storage space USS will hereinafter be indicated as non-reserved user space NRUS.

As a result, any conventional general purpose computer will recognize as occupied storage space the entire video-reserved storage section VRSS 80, i.e. the areas 71 corresponding to the video file VF and the areas 81 corresponding to the video reservation file VRF; therefore, such computer will write any computer data in the non-reserved user space NRUS 90 only. Since such computer is effectively prevented from writing any user data in the entire video-reserved storage section VRSS 80, not only are the video recordings in these areas 71 effectively protected against overwriting by computer data, but also the integrity of the non-written areas 72 needed for future video recordings is maintained.

It is noted that, from the information in the file allocation list FAL, no distinction can be made between the video reservation file VRF and other, i.e. “normal”, files.

The video reservation file VRF looks just like a normal file. In fact, the only difference between the video reservation file VRF and “normal” files is that the storage space 81 indicated by this file may be empty, i.e. does not need to contain data, and it may even be maiden space, i.e. never been written at all. The video reservation file VRF in principle is only a declaration, i.e. an entry in the file allocation list FAL. Thus, a parameter “information length” may be zero. The storage space 81 is allocated, but may be non-recorded. On the other hand, if desired, it is possible to write data, meaningful or not, into the storage space 81 indicated by the video reservation file VRF.

Video recording applications, when consulting the file allocation list FAL, will also see the video reservation file VRF. Conventional video recording applications may respect this file, in which case no further video recording is possible. However, video recording applications according to the present application are designed to recognize the status of the video reservation file VRF as a file just securing storage space for video applications and therefore available for use. An easy way to achieve this is to have a predetermined name for the video reservation file VRF defined in the video standard format.

An important aspect of the video reservation file VRF is that it claims storage space for later use, respected by other applications. The importance is not so much that it is assured that the disc contains a certain minimum amount of storage capacity, but more so that certain specific locations, i.e. address ranges, are reserved. Therefore, applications should not be allowed to relocate the video reservation file VRF. Preferably, the video reservation file VRF is declared as a non-relocatable file.

Effectively, the video reservation file VRF results in a soft-partitioning of the user storage space USS into one portion 80 for video use only and a second portion 90 available to other applications. It may be that, in practice, it appears that a user wishes to make a further video recording of a length larger than reserved by the video reservation file VRF, while the non-reserved user space NRUS 90 has storage space available adjacent to the video-reserved storage section VRSS 80. Preferably, the signal processing system 120 of the video recorder apparatus 100 is capable to redefine the video reservation file VRF such that the end is shifted towards the end of the user storage space USS, effectively increasing the video-reserved storage section VRSS 80 and decreasing the non-reserved user space NRUS 90.

On the other hand, it may also be that, in practice, it appears that a user wishes to store computer data of an amount more than the capacity of the free part of the non-reserved user space NRUS 90, while the free part of the video-reserved storage section VRSS 80 has storage space available at its end, i.e. adjacent to the non-reserved user space NRUS 90. Preferably, the signal processing system 120 of the video recorder apparatus 100 is capable to redefine, on command of a user, the video reservation file VRF such that the end is shifted away from the end of the user storage space USS, effectively decreasing the video-reserved storage section VRSS 80 and increasing the non-reserved user space NRUS 90.

In executing the present invention, the signal processing system 120 of the video recorder apparatus 100 will perform the following actions. After having received a command to write a video recording, the signal processing system 120 will look for a suitable location on disc, as usual, and it will write the video recording, as usual. After having completed the writing of the video recording, the signal processing system 120 declares into the file allocation list FAL the video reservation file VRF containing those portions 81 of the video-reserved storage section VRSS 80 which are still free for video recording (i.e. the difference between the video-reserved storage section VRSS 80 and the recorded areas 71). This may be executed by an entire new declaration of a VRF or by suitably updating an already existing VRF.

Thanks to the VRF written by the video application in accordance with the present invention, the video application has protected itself against writing actions by a computer application or the like. On the other hand, the VRF does not prevent the video application from writing in storage space outside the VRF.

It should be clear to a person skilled in the art that the present invention is not limited to the exemplary embodiments discussed above, but that various variations and modifications are possible within the protective scope of the invention as defined in the appending claims.

For instance, although it seems practical to have just one video reservation file VRF with a predetermined name, the present invention is not limited to such embodiment; it is very well possible to have two or more video reservation files with predetermined names.

Further, although in the above the video-reserved storage section VRSS 80 is shown as one contiguous part (extent) of the user storage space USS, it may also be that an application wishes to reserve storage space which is fragmented. For instance, it may be desirable to have storage space reserved close to spare storage spaces in order to assure that, in the case of a possible defective storage location, the distance between such defective location and spare storage space is always relatively small. As another example, for safety reasons it may be desirable to be able to store a certain file at different locations at relatively large distances from each other, so that, in the case of a damaged disc, the changes on recovery of the data of this file area increased.

Further, although in the above the video-reserved storage section VRSS 80 is shown as extending from the beginning of the USS (starting form the first address in USS) while the NRUS 90 ranges from the end of VRSS to the end of the USS, other configurations are possible as well. For instance, it may be advantageous if the USS has at its beginning an area available for writing computer data, instead of or as addition to the area 90 located at the end of the USS. In such case, the USS will have at least one video-free area 72 not corresponding to an extent 81 of the VRF.

Further, although in the above the video reservation file VRF is explained as only containing the addresses of those parts 81 of the reserved storage section VRSS 80 which are free, it is, in principle, possible that the video reservation file VRF also contains the addresses of those parts 71 of the reserved storage section VRSS 80 which are occupied, i.e. the video reservation file VRF may contain the entire reserved storage section VRSS 80. In such case, the same advantages as described above are achieved, while an additional advantage is achieved in that it is no longer necessary to update the video reservation file VRF after each write operation. However, this is only possible if the standard allows addresses being allocated to more than one file.

Further, it is noted that in the above the invention is explained for a case of two applications, i.e. a video recording application and a computer data writing application. However, the present invention is not restricted to such case. It is very well possible that a second application creates a second reservation file, effectively reserving for its own use a part of the space 90 left free by the first reservation file.

1. Method of writing an optical disc having a user storage space, the method comprising the steps of:
determining a reserved storage section of the user storage space for use by a specific application;
determining which parts of said reserved storage section are free for writing, i.e. not occupied;
allocating all addresses in those free parts to a reservation file.

2. Method according to claim 1, wherein the reservation file is declared into a file allocation list which is stored in a predetermined portion of storage space of the disc.

3. Method according to claim 1, wherein the reservation file has a predetermined name.

4. Method according to claim 1, wherein the reservation file is declared as a non-relocateable file.

5. Method according to claim 1, wherein the reservation file is an empty file.

6. Method of writing an optical disc having a user storage space, the method comprising the steps of:
writing user data into the user storage space in response to a write command;
after the writing operation of the user data is completed, performing the method steps according to claim 1.

7. User-writeable optical disc having a user storage space, and a file allocation list stored in a predetermined portion of storage space of the disc, the file allocation list containing at least one reservation file.

8. User-writeable optical disc having a user storage space, and a file allocation list stored in a predetermined portion of storage space of the disc, the file allocation list containing at least one reservation file, wherein the at least one reservation file has been declared in accordance with claim 1.

9. Method of writing information to an optical disc according to claim 7, the method comprising the steps of:
receiving a user command indicating an amendment to the size of said reserved storage section;
accordingly, defining a new start address and/or a new end address of the at least one reservation file;
updating the file allocation list in respect of the reservation file.

10. Method of writing information to an optical disc according to claim 7, the method comprising the steps of:
writing user data into the user storage space in response to a write command;
after the writing operation of the user data is completed, updating the file allocation list in respect of the reservation file.

11. Method according to claim 10, wherein addresses for writing the user data are selected on the basis of application-specific recording location information regarding location and extent of recorded areas.

12. Method according to claim 10, wherein, in order to determine addresses available for writing the user data, said file allocation list is consulted to determine the free parts of reserved storage space as secured by said at least one reservation file, and wherein addresses for writing the user data are selected within said free parts.

13. Method according to claim 12, wherein, if it appears that the size of the free area is insufficient to accommodate the information to be written, the following steps are taken:
determining whether the user storage space outside said reserved storage section, either by itself or in combination with the free area already found, contains a storage space portion suitable and sufficient for accommodating the information to be written, taking into account existing files as determined by said file allocation list;
allocating all addresses within said portion to a reservation file in order to increase the size of said reserved storage section.

14. Method according to claim 9, wherein the step of updating the file allocation list comprises the steps of:
determining which parts of said reserved storage section are still free for writing, i.e. not occupied;
allocating all addresses in those free parts to said at least one reservation file, and entering the updated at least one reservation file into said file allocation list; or, alternatively, updating the corresponding data in the file allocation list.

15. Apparatus, comprising a signal processing system capable of communicating with a disc drive system of a disc drive apparatus, the signal processing system being designed for executing a method according to claim 1.
